(19) United States
(12) Patent Application Publication
(10) Pub. No.: US 2015/0254153 A1
(43) Pub. Date: Sep. 10, 2015

(54) PERIPHERAL APPARATUS MANAGEMENT SYSTEM, PERIPHERAL APPARATUS OPERATING SYSTEM AND SHARING SYSTEM THEREOF

(71) Applicant: AVISION INC., Hsinchu (TW)

(72) Inventor: Chun-Chieh Liao, Diamond Bar, CA (US)

(73) Assignee: AVISION INC., Hsinchu (TW)

(21) Appl. No.: 14/271,355

(22) Filed: May 6, 2014

(30) Foreign Application Priority Data
Mar. 7, 2014 (TW) 103204007

(51) Int. Cl. G06F 11/30

(52) U.S. Cl. CPC G06F 11/3089

(57) ABSTRACT

The present disclosure illustrates a peripheral apparatus management system, peripheral apparatus operating system and sharing system thereof. The sharing system includes first electronic apparatus, second electronic apparatus and peripheral apparatus electrically connected with the second electronic apparatus. In the local area network, the peripheral apparatus is controlled remotely by the first electronic apparatus, via communication between a first apparatus driver module installed in the first electronic apparatus and a second apparatus driver module installed in the second electronic apparatus, so that the operation convenience of operating the peripheral apparatus can be improved. Besides, the user can operate this peripheral apparatus without running additional application program in the second electronic apparatus. The data generated by the peripheral apparatus in this system is output to the first electronic apparatus and cannot be accessed in the second electronic apparatus, so that this sharing system has better data confidentiality.

### CROSS-REFERENCE TO RELATED APPLICATION

This application claims the benefit of Taiwan Patent Application No. 103204007, filed on Mar. 7, 2014, in the Taiwan Intellectual Property Office, the disclosure of which is incorporated herein in its entirety by reference.

### BACKGROUND OF THE INVENTION

1. Field of the Invention

The present disclosure is related to a peripheral apparatus management system, a peripheral apparatus operating system and a sharing system thereof, particularly, to a management system of sharing a peripheral apparatus in LAN by communication between driver modules without a server.

2. Description of the Related Art

Traditionally, peripheral apparatuses applied in computer for inputting or outputting data comprise scanner, CD-ROM drive or disk drive. In consideration of cost and low frequency of use, companies or schools often just buy small amount of peripheral apparatuses which must be then shared to all users via LAN. In such sharing environment, the peripheral apparatus must be connected with a server directly. Users can just send requests remotely to the server via LAN for operating this peripheral apparatus, or operate this peripheral apparatus on the server directly.

The above manner has the following drawbacks. First, the application program being executed on the server may be interfered while the peripheral apparatus is generating data. Second, the data generated by the peripheral apparatus must be stored in the server and then be obtained by the user by the network or operating this server directly. However, the data confidentiality and the convenience of operation for users in the prior art is reduced efficiently.

The network scanner is taken as example for detail illustration. When a scanner is connected to one of computers in LAN, a push mode or pull mode is generally adopted to operate this scanner. In push mode, the user must stand in front of the scanner and select a “transmit” button on the interface of the scanner to deliver image file. Next, a network server activates a specific program on user's computer automatically to receive or process this image file. The drawback of this manner is that the image file must be stored in the network server first, so that the data confidentiality cannot be protected.

In pull mode, every user controls the network scanner by using an operational interface displayed on his/her computer. However, each user can modify or set up the setting of the network scanner, so the potential risk of failure of scanner exists and fewer companies adopt the pull mode to operate peripheral apparatuses.

### SUMMARY OF THE INVENTION

In view of problems in prior art, one of objectives of the present disclosure is to provide a peripheral apparatus management system, a peripheral apparatus operating system and a sharing system thereof, so as to improve convenience of operating the peripheral apparatus in LAN for user.

In view of problems in prior art, one of objectives of the present disclosure is to provide a peripheral apparatus management system, a peripheral apparatus operating system and a sharing system thereof, so as to prevent executed application programs on the server from being affected by the peripheral apparatus.

In view of problems in prior art, one of objectives of the present disclosure is to provide a peripheral apparatus management system, a peripheral apparatus operating system and a sharing system thereof, so that the data output by the peripheral apparatus has better data confidentiality in LAN.

According to the objectives of the present disclosure, the present disclosure provides a peripheral apparatus management system applied to a first electronic apparatus and a second electronic apparatus in a local area network. The peripheral apparatus is connected electrically with the second electronic apparatus. The peripheral apparatus management system comprises a first apparatus driver module and a second apparatus driver module, and the first apparatus driver module is installed in the first electronic apparatus and comprises a first apparatus driving unit and a first agent unit. The first apparatus driving unit is used to receive a request sent from an application program of the first electronic apparatus, and generate a driving instruction. The first agent unit transmits the driving instruction to the local area network. The second apparatus driver module is installed in the second electronic apparatus and comprises a second apparatus driving unit and a second agent unit. The second apparatus driving unit is used to drive the peripheral apparatus. The second agent unit listens to a network port of the second electronic apparatus for receiving the driving instruction, or probes and accepts a packet containing the driving instruction on the local area network for every time period, and then transmits the driving instruction to the second apparatus driving unit. The second apparatus driving unit controls the peripheral apparatus to output data according to the driving instruction. The second apparatus driver module transmits data to the first apparatus driver module via the local area network.

Preferably, the first electronic apparatus further comprises a screen to display an operational interface of the application program. The operational interface is used to generate the request and display a usage state of the peripheral apparatus.

Preferably, the first apparatus driver module or the second apparatus driver module is executed under a kernel mode, so that application programs executed under a user mode in the first electronic apparatus or the second electronic apparatus are not affected by the first apparatus driver module or the second apparatus driver module.

Preferably, the first apparatus driver module is connected with the second apparatus driver module by user's assign or the first apparatus driver module can automatically probe the peripheral apparatus existing in the local area network, via TCP/IP protocol.

Preferably, the peripheral apparatus comprises a scanner, a disk drive, a floppy, a CD-ROM drive or a tape drive.

Preferably, the peripheral apparatus is connected to the second electronic apparatus via USB port, SCSI port, IDE port or 1394 port.

Preferably, the second agent unit returns a busy message to the first agent unit when the second agent unit listens to the driving instruction but the peripheral apparatus is in busy state.

Preferably, the second apparatus driving unit comprises a queue. When the peripheral apparatus is in busy state, the queue stores the received driving instruction and then the driving instruction is transmitted to control the peripheral apparatus later according to first-in-first-out order.

Preferably, the data is not stored in the second electronic apparatus, or the data cannot be accessed by the program executed in the second electronic apparatus.

According to above objective, the present disclosure further provides a peripheral apparatus operating system applied to a first electronic apparatus and a second electronic apparatus in a local area network. The peripheral apparatus operating system comprises a peripheral apparatus, a first apparatus driver module and a second apparatus driver module. The peripheral apparatus is electrically connected with the second electronic apparatus. The first apparatus driver module is installed in the first electronic apparatus, and comprises a first apparatus driving unit and a first agent unit. The first apparatus driving unit is used to receive a request from an application program of the first electronic apparatus, and generate a driving instruction. The first agent unit transmits the driving instruction to the local area network. The second apparatus driver module is installed in the second electronic apparatus, and comprises a second apparatus driving unit and a second agent unit. The second apparatus driving unit is used to drive the peripheral apparatus. The second agent unit listens to a network port of the second electronic apparatus for receiving the driving instruction, or actively probes and accepts a packet containing the driving instruction on the local area network for every time period, and then transmits the driving instruction to the second apparatus driving unit. The second apparatus driving unit controls the peripheral apparatus to output data according to the driving instruction. The second apparatus driver module transmits data to the first apparatus driver module via the local area network.

Preferably, the first electronic apparatus further comprises a screen to display an operational interface of the application program. The operational interface is used to generate the request and display a usage state of the peripheral apparatus.

Preferably, the first apparatus driver module or the second apparatus driver module is executed under a kernel mode, so that application programs executed under a user mode in the first electronic apparatus or the second electronic apparatus are not affected by the first apparatus driver module or the second apparatus driver module.

Preferably, the first apparatus driver module is connected with the second apparatus driver module by user's assign or the first apparatus driver module can automatically probe the peripheral apparatus existing in the local area network, via TCP/IP protocol.

Preferably, the peripheral apparatus comprises a scanner, a disk drive, a floppy, a CD-ROM drive or a tape drive.

Preferably, the peripheral apparatus is connected to the second electronic apparatus via USB port, SCSI port, IDE port or 1394 port.

Preferably, the second agent unit returns a busy message to the first agent unit when the second agent unit listens to the driving instruction but the peripheral apparatus is in a busy state.

Preferably, the second apparatus driving unit comprises a queue. When the peripheral apparatus is in the busy state, the received driving instruction is stored in the queue and then the driving instruction is transmitted to control the peripheral apparatus later according to a first-in-first-out order.

Preferably, the data is not stored in the second electronic apparatus or the data cannot be accessed by program executed in the second electronic apparatus.

According to above objective, the present disclosure further provides a peripheral apparatus sharing system applied to a local area network. The peripheral apparatus sharing system comprises a peripheral apparatus, a first electronic apparatus, and a second electronic apparatus electrically connected with the peripheral apparatus. The first electronic apparatus comprises a first apparatus driver module which comprises a first apparatus driving unit and a first agent unit. The first apparatus driving unit is used to receive a request from an application program of the first electronic apparatus, and generate a driving instruction. The first agent unit transmits the driving instruction to the local area network. The second electronic apparatus comprises a second apparatus driver module which comprises a second apparatus driving unit and a second agent unit. The second apparatus driving unit is used to drive the peripheral apparatus. The second agent unit listens to a network port of the second electronic apparatus for receiving the driving instruction, or actively probes and accepts a packet containing the driving instruction on the local area network for every time period, and then transmits the driving instruction to the second apparatus driving unit. The second apparatus driving unit controls peripheral apparatus to output data according to the driving instruction. The second apparatus driver module transmits data to the first apparatus driver module via the local area network.

Preferably, the first electronic apparatus further comprises a screen to display an operational interface of the application program. The operational interface is used to generate the request and display a usage state of the peripheral apparatus.

### BRIEF DESCRIPTION OF THE DRAWINGS

The detailed structure, operating principle and effects of the present disclosure will now be described in more details hereinafter with reference to the accompanying drawings that show various embodiments of the invention as follows.

FIG. 1 is a block view of a peripheral apparatus management system in accordance with the present disclosure.

FIG. 2 is a schematic view of the peripheral apparatus management system in accordance with the present disclosure.

FIG. 3 is a block view of a peripheral apparatus operating system in accordance with the present disclosure.

FIG. 4 is a block view of a peripheral apparatus sharing system in accordance with the present disclosure.

FIG. 5 is a schematic view of the peripheral apparatus sharing system in accordance with the present disclosure.

### DETAILED DESCRIPTION OF THE PREFERRED EMBODIMENTS

Those skilled in the art will understand that since elements shown in the accompanying drawings may be scaled up or down for convenience in description, the present disclosure is not constrained to the size or shape of the elements illustrated in the drawings, rather various variations and other equivalent embodiments are also contemplated.

Hereinafter, embodiments will be described more fully with reference to the accompanying drawings, in which exemplary embodiments of peripheral apparatus management system, peripheral apparatus operating system and sharing system thereof in accordance with the invention are shown. However, they may be embodied in many different forms and should not be construed as limited to the exemplary embodiments set forth herein. Rather, these embodiments are provided so that this disclosure will be thorough and complete, and will fully convey the scope of the invention to those skilled in the art. The terminology used herein is for the purpose of describing particular embodiments only and is not intended to be limiting of the invention. For clarification, the same elements or equivalents are referred to by the same reference numerals throughout the specification.

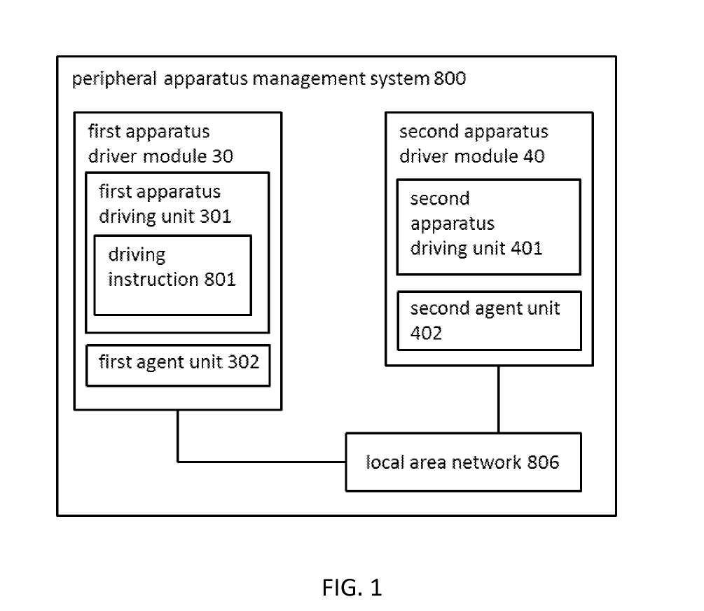

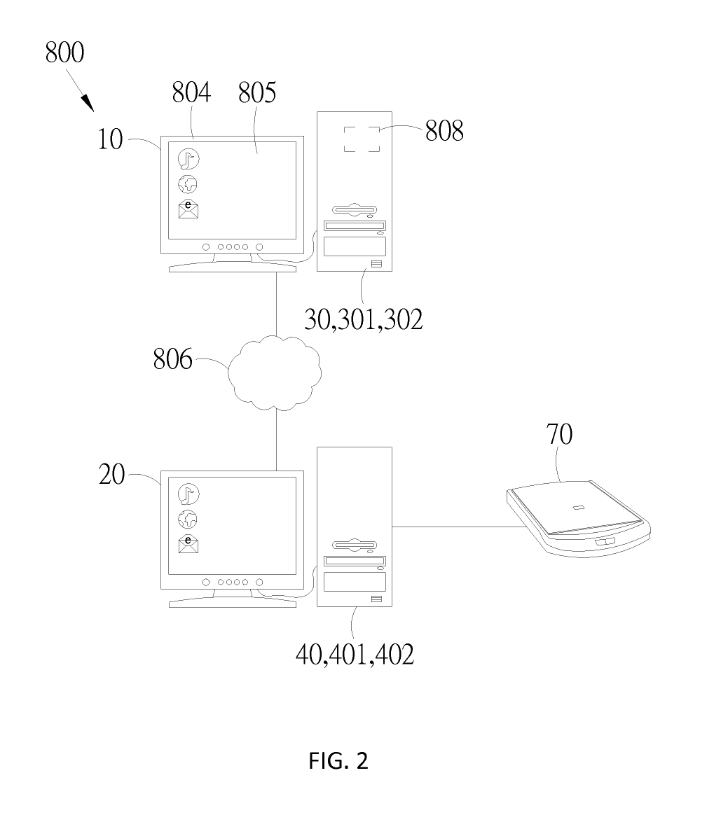

FIG. 1 and FIG. 2 are block view and schematic view of a peripheral apparatus management system in accordance with the present disclosure, respectively. As shown in FIG. 1 and FIG. 2, a peripheral apparatus management system 800 is applied to a first electronic apparatus 10 and a second electronic apparatus 20 connected in a local area network 806. The peripheral apparatus 70 is connected electrically with the second electronic apparatus 20. Preferably, the local area network 806 comprises a wireless network or a wired network. The first electronic apparatus 10 or the second electronic apparatus 20 comprises a computer, a server or a laptop computer, and the peripheral apparatus 70 comprises a scanner, a disk drive, a floppy, a CD-ROM drive or a tape drive.

The peripheral apparatus management system 800 comprises a first apparatus driver module 30 and a second apparatus driver module 40 which are drivers for peripheral apparatus 70 and installed in the first electronic apparatus 10 and the second electronic apparatus 20, respectively. The first apparatus driver module 30 comprises a first apparatus driving unit 301 and a first agent unit 302 which are application programs generated by compiled sub-function of a program code. The first apparatus driving unit 301 is used to receive a request from an application program executed in the first electronic apparatus 10, and then generate a driving instruction 801 correspondingly. The first agent unit 302 transmits the driving instruction 801 to the local area network 806.

The second apparatus driver module 40 comprises a second apparatus driving unit 401 and a second agent unit 402 which are application programs generated by compiled sub-function of a program code. The second agent unit 402 can receive the driving instruction 801 by two ways. In the first way, the second agent unit 402 listens to the network port of the second electronic apparatus 20 to receive the driving instruction 801. In the second way, the second agent unit 402 probes the local area network 806 actively for every time period and receives a packet containing the driving instruction 801 being detected to exist in the local area network 806.

Upon receipt of the driving instruction 801, the second agent unit 402 transmits the driving instruction 801 to the second apparatus driving unit 401 for controlling the peripheral apparatus 70 to output data.

In detail, the first apparatus driver module 30 or the second apparatus driver module 40 is executed under a kernel mode of operation system, so that the application program 807 executed under a user mode in the first electronic apparatus 10 or the second electronic apparatus 20 are not affected by the first apparatus driver module 30 or the second apparatus driver module 40.

In detail, the peripheral apparatus 70 is connected to the second electronic apparatus 20 via USB port, SCSI port, IDE port or 1394 port. When the second agent unit 402 listens to the driving instruction 801 but the peripheral apparatus 70 is in state of being used, the second apparatus driving unit 401 uses a queue to store the received driving instruction 801 and the second agent unit 402 returns a busy message to the first agent unit 302. Next, the second apparatus driving unit 40 transmits the driving instruction 801 to control the peripheral apparatus 70 according to a first-in-first-out order.

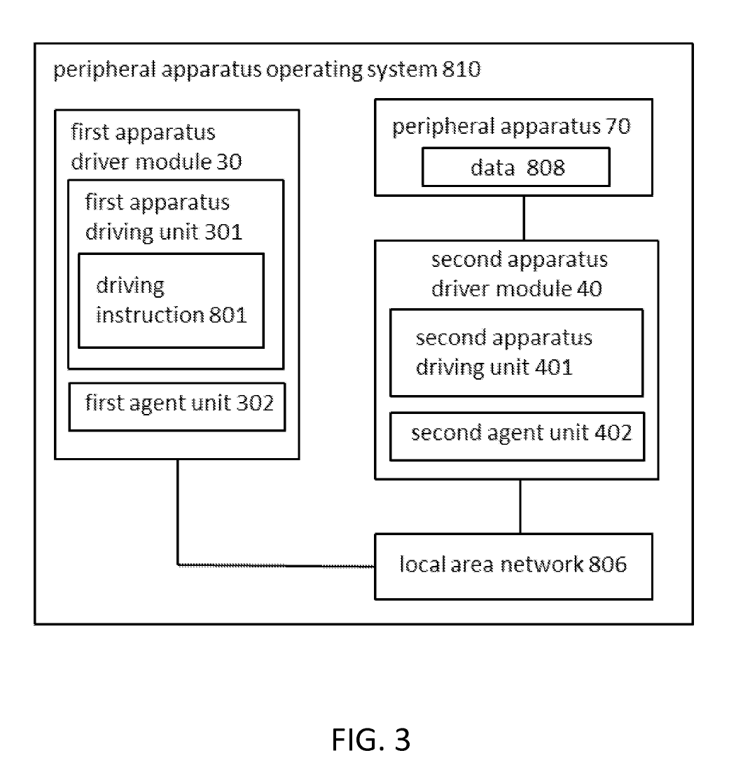

FIG. 3 is a block view of a peripheral apparatus operating system in accordance with the present disclosure. As shown in FIG. 3, the peripheral apparatus operating system 810 is applied to a first electronic apparatus 10 shown in FIG. 2 and a second electronic apparatus 20 shown in FIG. 2 within a local area network 806. The peripheral apparatus operating system 810 comprises a peripheral apparatus 70, a first apparatus driver module 30 and a second apparatus driver module 40. The peripheral apparatus 70 is connected electrically with the second electronic apparatus 20. In the peripheral apparatus operating system 810, driver modules are used to communicated to each other and the same as the first apparatus driver module 30 and second apparatus driver module 40 shown in FIG. 1, so detail description is be omitted.

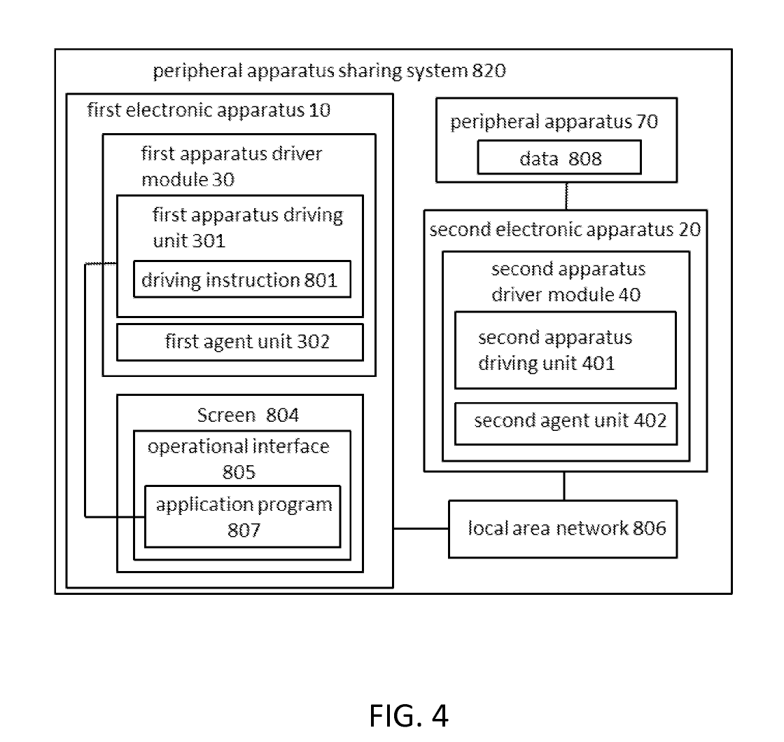

FIG. 4 is a block view of a peripheral apparatus sharing system in accordance with the present disclosure. As shown in FIG. 4, a peripheral apparatus sharing system 820 is applied to a local area network 806, and a first electronic apparatus 10, a second electronic apparatus 20 and a peripheral apparatus 70 connected electrically with the second electronic apparatus 20 are located within the local area network 806. The first electronic apparatus 10 comprises a first apparatus driver module 30 and the second electronic apparatus 20 comprises a second apparatus driver module 40. In the peripheral apparatus sharing system 820, driver modules are used to communicate each other as well as the first apparatus driver module 30 and second apparatus driver module 40 shown in FIG. 1, so detail description is be omitted.

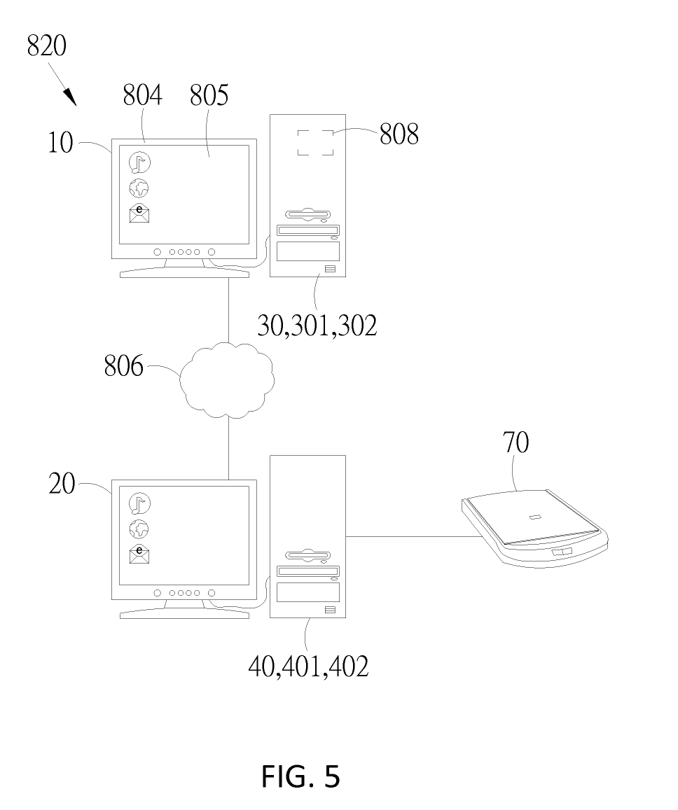

FIG. 5 is a schematic view of the peripheral apparatus sharing system in accordance with the present disclosure. As shown in FIG. 5, the first electronic apparatus 10 is connected to the second electronic apparatus 20 via a local area network 806. A scanner is taken as an example for the peripheral apparatus 70 of this schematic view, and the peripheral apparatus 70 is connected to the second electronic apparatus 20 via USB port, SCSI, IDE port or 1394 port.

After the first apparatus driver module 30 and the second apparatus driver module 40 are installed in the first electronic apparatus 10 and the second electronic apparatus 20 respectively, the first electronic apparatus 10 can be assigned by user to connect a network address of the second apparatus driver module 40 within the local area network 806 via TCP/IP protocol. Besides, the first electronic apparatus 10 can also probe the peripheral apparatus 70 located within the local area network 806 via TCP/IP protocol, so as to obtain the network address of the second electronic apparatus 20 for further communication with the second apparatus driver module 40.

The first electronic apparatus 10 further comprises a screen 804 to display an operational interface 805 of the application program 807. This operational interface 805 is used to generate a driving instruction 801 for requesting the peripheral apparatus 70 and display a usage state of the peripheral apparatus 70.

When the driving instruction 801 is generated from the operational interface 805 by the user, the network port of the second electronic apparatus 20 listens to and receives this driving instruction 801 via local area network 806. After the driving instruction 801 is received and the peripheral apparatus 70 is in the busy state, the second agent unit 402 will return a busy message to the first agent unit 302, and store the received driving instruction 801 in a queue, and transmit the driving instruction 801 from the queue to control the peripheral apparatus 70 according to a first-in-first-out order later. In this embodiment, the second electronic apparatus 20 listening to this driving instruction 801 is taken as example, but it is not limited thereto. The second electronic apparatus 20 can also probe whether any packet containing the driving instruction 801 exists within the local area network 806 for every time period. When probing existence of the packet, the second electronic apparatus 20 receives the packet and obtains the driving instruction 801 to execute subsequent action.

It is noted that the second apparatus driver module 40 transmits data 808 to the first apparatus driver module 30 directly via local area network 806. It means that data 808 does not store in second electronic apparatus 20, or the data 808 cannot be accessed by program executed in the second electronic apparatus 20.

In summary, the peripheral apparatus management system, peripheral apparatus operating system and sharing system thereof in accordance with the present disclosure have following advantages. First, data generated in the peripheral apparatus can only be accessed by the first electronic apparatus 10 in the local area network, so the present disclosure has advantage of data confidentiality. Second, every computer within the local area network can control this peripheral apparatus via network by communication between driver modules, so it can prevent user's application programs from being affected during the communication. Thirdly, user can control the peripheral apparatus without the server, so the convenience of operation is improved efficiently.

Although a few embodiments have been described, those skilled in the art will readily appreciate that many modifications are possible in the embodiments without materially departing from the novel teachings and advantages of the invention. While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A peripheral apparatus management system, applied to a first electronic apparatus and a second electronic apparatus within a local area network, a peripheral apparatus connected electrically to the second electronic apparatus, and the peripheral apparatus management system comprising:
a first apparatus driver module, installed in the first electronic apparatus, the first apparatus driver module comprising:
a first apparatus driving unit, receiving a request from an application program of the first electronic apparatus, and generating a driving instruction; and
a first agent unit, transmitting the driving instruction to the local area network; and
a second apparatus driver module, installed in the second electronic apparatus, and the second apparatus driver module comprising:
a second apparatus driving unit, driving the peripheral apparatus; and
a second agent unit, listening to a network port of the second electronic apparatus to receive the driving instruction, or actively probing and accepting a packet containing the driving instruction on the local area network for every time period, and then transmitting the driving instruction to the second apparatus driving unit, and the second apparatus driving unit controlling the peripheral apparatus to output data according to the driving instruction;
wherein the second apparatus driver module transmits the data to the first apparatus driver module via the local area network.

2. The peripheral apparatus management system of claim 1, wherein the first electronic apparatus further comprises a screen to display an operational interface of the application program, and the operational interface is used to generate the request and display a usage state of the peripheral apparatus.

3. The peripheral apparatus management system of claim 1, wherein the first apparatus driver module or the second apparatus driver module is executed under a kernel mode, so that the application program executed under a user mode in the first electronic apparatus or the second electronic apparatus is not affected by the first apparatus driver module or the second apparatus driver module.

4. The peripheral apparatus management system of claim 1, wherein the first apparatus driver module is connected with the second apparatus driver module by user's assign or the first apparatus driver module automatically probes the peripheral apparatus existing in the local area network, via TCP/IP protocol.

5. The peripheral apparatus management system of claim 1, wherein the peripheral apparatus comprises a scanner, a disk drive, a floppy, a CD-ROM drive or a tape drive.

6. The peripheral apparatus management system of claim 1, wherein the peripheral apparatus is connected to the second electronic apparatus via USB port, SCSI port, IDE port or 1394 port.

7. The peripheral apparatus management system of claim 1, wherein the second agent unit returns a busy message to the first agent unit when the second agent unit listens to the driving instruction but the peripheral apparatus is in a busy state.

8. The peripheral apparatus management system of claim 7, wherein the second apparatus driving unit comprises a queue, when the peripheral apparatus is in the busy state, the received driving instruction is stored in the queue and the driving instruction is transmitted to control the peripheral apparatus later according to a first-in-first-out order.

9. The peripheral apparatus management system of claim 1, wherein the data is not stored in the second electronic apparatus or the data cannot be accessed by the program executed in the second electronic apparatus.

10. A peripheral apparatus operating system, applied to a first electronic apparatus and a second electronic apparatus within a local area network, the peripheral apparatus operating system comprising:
a peripheral apparatus, connected electrically with the second electronic apparatus;
a first apparatus driver module, installed in the first electronic apparatus, and the first apparatus driver module comprising:
a first apparatus driving unit, receiving a request from an application program of the first electronic apparatus, and generating a driving instruction; and
a first agent unit, transmitting the driving instruction to the local area network; and
a second apparatus driver module, installed in the second electronic apparatus, and the second apparatus driver module comprising:
a second apparatus driving unit, driving the peripheral apparatus; and
a second agent unit, listening to a network port of the second electronic apparatus to receive the driving instruction, or actively probing and accepting a packet containing the driving instruction on the local area network for every time period, and then transmitting the driving instruction to the second apparatus driving unit, and the second apparatus driving unit controlling the peripheral apparatus to output data according to the driving instruction;
wherein the second apparatus driver module transmits the data to the first apparatus driver module via the local area network.

11. The peripheral apparatus operating system of claim 10, wherein the first electronic apparatus further comprises a screen to display the an operational interface of the application program, and the operational interface is used to generate the request and display a usage state of the peripheral apparatus.

12. The peripheral apparatus operating system of claim 10, wherein the first apparatus driver module or the second apparatus driver module is executed under a kernel mode, so that the application program executed under a user mode in the first electronic apparatus or the second electronic apparatus is not affected by the first apparatus driver module or the second apparatus driver module.

13. The peripheral apparatus operating system of claim 10, wherein the first apparatus driver module is connected with the second apparatus driver module by user's assign or the first apparatus driver module automatically probes the peripheral apparatus existing in the local area network, via TCP/IP protocol.

14. The peripheral apparatus operating system of claim 10, wherein the peripheral apparatus comprises a scanner, a disk drive, a floppy, a CD-ROM drive or a tape drive.

15. The peripheral apparatus operating system of claim 10, wherein the peripheral apparatus is connected to the second electronic apparatus via USB port, SCSI port, IDE port or 1394 port.

16. The peripheral apparatus operating system of claim 10, wherein the second agent unit returns a busy message to the first agent unit when the second agent unit listens to the driving instruction but the peripheral apparatus is in a busy state.

17. The peripheral apparatus operating system of claim 16, wherein the second apparatus driving unit comprises a queue, when the peripheral apparatus is in the busy state, the received driving instruction is stored in the queue and then the driving instruction is transmitted to control the peripheral apparatus later according to a first-in-first-out order.

18. The peripheral apparatus operating system of claim 10, wherein the data is not stored in the second electronic apparatus or the data cannot be accessed by the program executed in the second electronic apparatus.

19. A peripheral apparatus sharing system, applied to a local area network, the peripheral apparatus sharing system comprising:
a peripheral apparatus;
a first electronic apparatus, comprising:
a first apparatus driver module, comprising a first apparatus driving unit receiving a request from an application program of the first electronic apparatus, and generating a driving instruction; and
a first agent unit transmitting the driving instruction to the local area network; and
a second electronic apparatus, connected electrically to the peripheral apparatus, and comprising:
a second apparatus driver module, comprising a second apparatus driving unit driving the peripheral apparatus; and
a second agent unit, listening to a network port of the second electronic apparatus to receive the driving instruction, or actively probing and accepting a packet containing the driving instruction on the local area network for every time period, and then transmitting the driving instruction to the second apparatus driving unit, and the second apparatus driving unit controlling the peripheral apparatus to output data according to the driving instruction;
wherein the second apparatus driver module transmits the data to the first apparatus driver module via the local area network.

20. The peripheral apparatus sharing system of claim 19, wherein the first electronic apparatus further comprises a screen to display the an operational interface of the application program, and the operational interface is used to generate the request and display a usage state of the peripheral apparatus.
